(19) United States
(12) Patent Application Publication
(10) Pub. No.: US 2009/0128414 A1
(43) Pub. Date: May 21, 2009

(54) HIGH GAIN OMNI-DIRECTIONAL ANTENNA

(75) Inventor: Jr-Ren JENG, Taipei (TW)

Correspondence Address: Workman Nydegger;1000 Eagle Gate Tower, 60 East South Temple, Salt Lake City, UT, 84111, US

(73) Assignee: SMARTANT TELECOM CO., LTD., Jhudong Township (TW)

(21) Appl. No.: 11/941,225

(22) Filed: Nov. 16, 2007

(51) Int. Cl. H01Q 9/04

(52) U.S. Cl. 343/700 MS

(57) ABSTRACT

A high gain omni-directional antenna includes a substrate, a signal feed-in portion, a first radiating unit, and a second radiating unit. The first radiating unit and second radiating unit respectively have a first radiation contact and a second radiation contact, for connecting the first radiating unit and the second radiating unit in series so as to form a circular closed loop. The high gain omni-directional antenna avoids the coupling effect between the signal line and the radiating end of the conventional high gain omni-directional antenna, and further solves the problem of excessively high directivity caused by the distance between the signal line and the radiating end. The design of the ring antenna of the high gain omni-directional antenna can raise the impedance and also realize a broader bandwidth.

### BACKGROUND OF THE INVENTION

1. Field of Invention

The present invention relates to a printed circuit board (PCB) antenna, and more particularly to a high gain omni-directional antenna.

2. Related Art

With the development of wireless communication technology, users can transmit information through a wireless communication system without being limited by the terrain. Antennae are important elements for wireless communication, and currently, the manufacturers prefer the PCB method for fabricating an antenna, since the manufacturing is easy and the cost is low.

The current wireless transmission standard is constituted by the Institute of Electrical and Electronics Engineers (IEEE), which promotes the application of the wireless transmission technology, and ensures that equipments of a variety of manufacturers are compatible and stable.

Referring to FIGS. 1A and 1B, FIG. 1A is a front view of a conventional high gain omni-directional antenna, illustrating an antenna substrate 100, a signal feed-in portion 10, a metal circuit 11, and a first radiating unit 20. FIG 1B is a rear view of a conventional high gain omni-directional antenna, illustrating an antenna substrate 100, a signal feed-in portion 10, a metal circuit 12, and a second radiating unit 30. The gain of a general omni-directional antenna is not high. In order to increase the gain, usually, a plurality of open dipole antennae is connected in series. However, in order to realize the impedance matching between the serially-connected radiating units, a wider metal wire is fabricated on the metal circuit of the open dipole antenna to transmit signals. A wider metal circuit reduces the distance between the metal wire and the radiating end, such that the signal transmitted on the metal wire influences the signal on the radiating end, thus causing the coupling effect between the metal wire and the radiating end. The coupling effect between the metal wire and the radiating end not only influences the impedance matching between the radiating units, but also limits the width of the frequency band. On the other hand, if the distance between the metal wire and the radiating end is increased to avoid the coupling effect therebetween, the directivity of the omni-directional antenna may easily become excessively high.

Therefore, researchers are in urgent need of solving the problem how to provide a radiation field pattern with high gain and wider broadband.

### SUMMARY OF THE INVENTION

Accordingly, the present invention is directed to a high gain omni-directional antenna, which adopts the design of connecting the radiating units in series through the first radiation contacts and second radiation contacts to form a circular loop. The characteristic of high impedance of the circular dipole antenna realizes a wider broadband as compared with the prior art.

The high gain omni-directional antenna of the present invention includes a substrate, a signal feed-in portion, a first radiating unit, and a second radiating unit. The first and second radiating units respectively have a first radiation contact and a second radiation contact, for connecting the first and second radiating units in series so as to form a circular closed loop. The first and second radiating units may have the same geometrical graphics symmetrical in position, for example, may be bar, rectangular, and finger shaped. The first radiating units and second radiating units may also have different geometrical graphics.

The gain omni-directional antenna uses the metal circuit of the signal feed-in portion to distribute a feed-in signal to the corresponding radiating unit. As the pins of the first and second radiating units are connected in series, a circular closed loop is formed, thus providing a characteristic of high impedance. Therefore, the present invention achieves the impedance matching, and avoids the coupling effect resulting from widening the signal line, thereby realizing a wider broadband as compared with the prior art.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1A is a schematic view of a first side of a conventional high gain omni-directional antenna;

FIG. 1B is a schematic view of a second side of a conventional high gain omni-directional antenna;

FIG. 2A is a schematic view of a first surface according to a first embodiment of the present invention;

FIG. 2B is a schematic view of a second surface according to a first embodiment of the present invention;

FIG. 3 is a schematic view of a second embodiment of the present invention;

FIG. 4A is a schematic front view of a first surface according to a third embodiment of the present invention;

FIG. 4B is a schematic front view of a second surface according to a third embodiment of the present invention;

FIG. 5 shows a relation of directivity versus frequency of a field according to the second embodiment of the present invention;

FIG. 6A is a diagram showing a two-dimensional radiation field pattern on a horizontal plane of the second embodiment of the present invention, in which a frequency of 2.2 GHz is taken for test;

FIG. 6B is a diagram showing a two-dimensional radiation field pattern on a horizontal plane of the second embodiment of the present invention, in which a frequency of 2.3 GHz is taken for test;

FIG. 6C is a diagram showing a two-dimensional radiation field pattern of the second embodiment of the present invention on a horizontal plane, in which a frequency of 2.4 GHz is taken for test;

FIG. 6D is a diagram showing a two-dimensional radiation field pattern on a horizontal plane of the second embodiment of the present invention, in which a frequency of 2.5 GHz is taken for test;

FIG. 6E is a diagram showing a two-dimensional radiation field pattern on a horizontal plane of the second embodiment of the present invention, in which a frequency of 2.6 GHz is taken for test;

FIG. 6F is a diagram showing a two-dimensional radiation field pattern on a horizontal plane of the second embodiment of the present invention, in which a frequency of 2.7 GHz is taken for test;

FIG. 6G is a diagram showing a two-dimensional radiation field pattern on a horizontal plane of the second embodiment of the present invention, in which a frequency of 2.8 GHz is taken for test;

FIG. 7A is a diagram showing a two-dimensional radiation field pattern on a vertical plane of the second embodiment of the present invention, in which a frequency of 2.2 GHz is taken for test;

FIG. 7B is a diagram showing a two-dimensional radiation field pattern on a vertical plane of the second embodiment of the present invention, in which a frequency of 2.3 GHz is taken for test;

FIG. 7C is a diagram showing a two-dimensional radiation field pattern on a vertical plane of the second embodiment of the present invention, in which a frequency of 2.4 GHz is taken for test;

FIG. 7D is a diagram showing a two-dimensional radiation field pattern on a vertical plane of the second embodiment of the present invention, in which a frequency of 2.5 GHz is taken for test;

FIG. 7E is a diagram showing a two-dimensional radiation field pattern on a vertical plane of the second embodiment of the present invention, in which a frequency of 2.6 GHz is taken for test;

FIG. 7F is a diagram showing a two-dimensional radiation field pattern on a vertical plane of the second embodiment of the present invention, in which a frequency of 2.7 GHz is taken for test; and

FIG. 7G is a diagram showing a two-dimensional radiation field pattern on a vertical plane of the second embodiment of the present invention, in which a frequency of 2.8 GHz is taken for test.

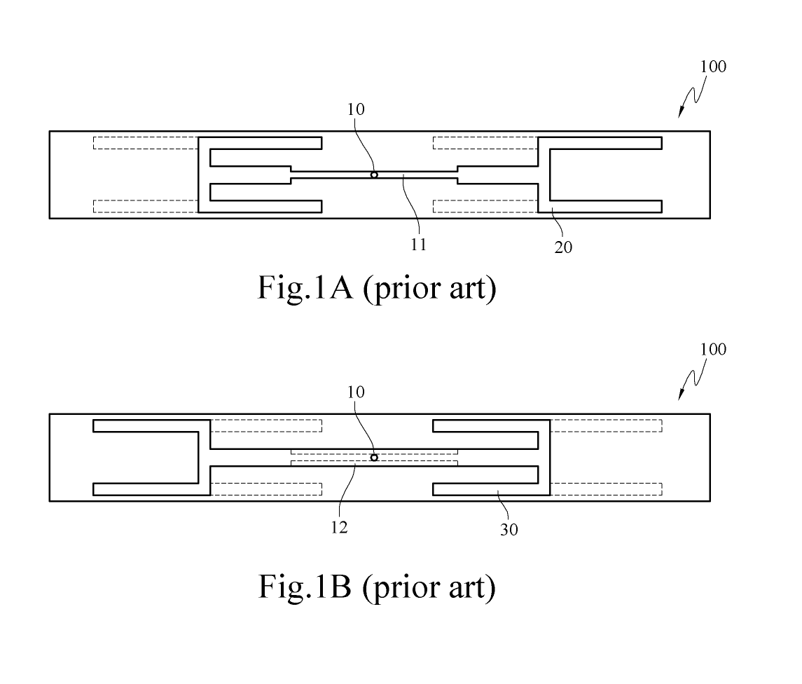

### DETAILED DESCRIPTION OF THE INVENTION

The features and practice of the present invention will be illustrated in detail below with the accompanying drawings.

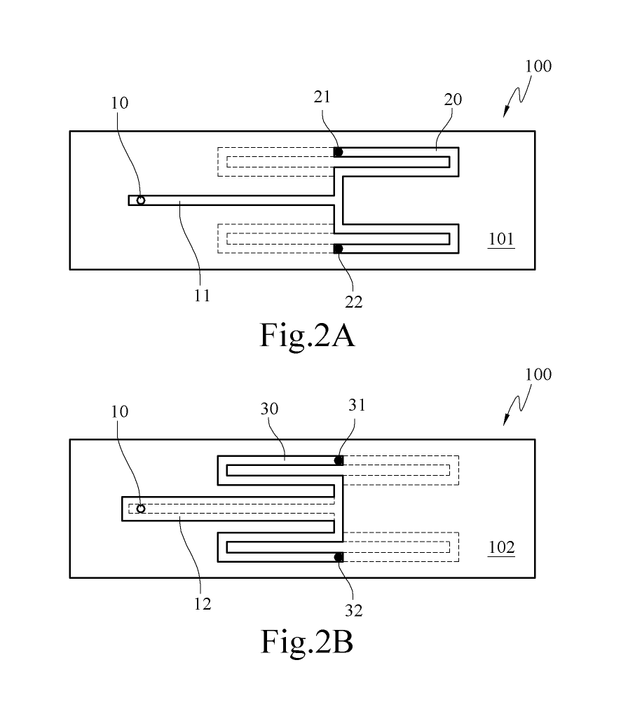

Referring to FIGS. 2A and 2B, schematic views of a first embodiment of the present invention are shown. FIG. 2A is a schematic view of a first surface according to the first embodiment of the present invention, and FIG. 2B is a schematic view of a second surface according to the first embodiment of the present invention. As shown in FIGS. 2A and 2B, the gain omni-directional antenna includes a signal feed-in portion 10, a first radiating unit 20, and a second radiating unit 30. The substrate 100 is generally a PCB, and definitely, may be substrates of other types. The substrate 100 is a rigid board or a soft flexible board. The material of the rigid board is glassfiber, bakelite, or other materials. The material of the soft flexible board is PI, PET, or other materials. Moreover, the substrate 100 has a first surface 101 and a second surface 102 opposite to the first surface 101. The antenna graphics on the first surface 101 and the second surface 102 are symmetrical.

Referring to FIG. 2A, a signal feed-in portion 10, a first radiating unit 20, and a first radiation contact are located on the first surface 101, and the metal circuit 11 is formed on the first surface 101.

The signal feed-in portion 10 is used to receive a feed-in signal of a predetermined frequency, and a metal circuit 11 extends in the signal feed-in portion 10. The circuit impedance of the metal circuit 11 matches the circuit impedance of the first radiating unit 20. The metal circuit 11 transmits the received feed-in signal to the first radiating unit 20.

The first radiating unit 20 is connected to the signal feed-in portion 10 through the metal circuit 11, for receiving and radiating the feed-in signal. The shape of the first radiating unit 20 is, but not limited to, geometrical graphics such as bar or finger shaped.

The first radiation contact including a first sub-contact 21 and a second sub-contact 22 is located on the first radiating unit 20. The first sub-contact 21 and the second sub-contact 22 are connected to the symmetrical third sub-contact 31 and fourth sub-contact 32 in FIG. 2B, such that the first radiating unit 20 and the second radiating unit 30 form a circular closed loop.

Referring to FIG. 2B, the second surface 102 has a metal circuit 12. The metal circuit 12 includes a signal feed-in portion 10, a second radiating unit 30, and a second radiation contact. The metal circuit 12 on the second surface 102 is symmetrical to the metal circuit 11 on the first surface 101. However, the metal circuit 12 is wider than the metal circuit 11, i.e., the first radiating unit 20 and the second radiating unit 30 extend in opposite directions, and have symmetrical antenna graphics.

The signal feed-in portion 10 is used to receive a feed-in signal of a predetermined frequency, and a metal circuit 12 extends in the signal feed-in portion 10. The circuit impedance of the metal circuit 12 matches the circuit impedance of the second radiating unit 30. The signal feed-in portion 10 transmits the received feed-in signal to the second radiating unit 30.

The second radiating unit 30 is connected to the signal feed-in portion 10 through the metal circuit 12, for receiving and radiating the feed-in signal. The antenna graphic of the second radiating unit 30 is identical and symmetrical to that of the first radiating unit 20.

The second radiation contact including a third sub-contact 31 and a fourth sub-contact 32 is located on the second radiating unit 30. The third sub-contact 31 and the fourth sub-contact 32 are connected to the symmetrical first sub-contact 21 and second sub-contact 22 in FIG. 2A, such that the first radiating unit 20 and the second radiating unit 30 form a circular closed loop. The first sub-contact 21 is connected in series with the third sub-contact 31 by means of directly welding the first sub-contact 21 and the third sub-contact 31 via holes penetrating the PCB in an embodiment after using a drilling machine to pass through the sub-contact of the PCB. The second sub-contact 22 is connected in series with the fourth sub-contact 32 by means of directly welding the second sub-contact 22 and the second sub-contact 32 via holes penetrating the PCB in an embodiment after using a drilling machine to pass through the sub-contact of the PCB. In another embodiment, the first sub-contact 21 and the first sub-contact 31, and the second sub-contact 22 and the second sub-contact 32 may be connected by wiring in the PCB, so as to make the first radiating unit 20 and the second radiating unit 30 form a circular closed loop.

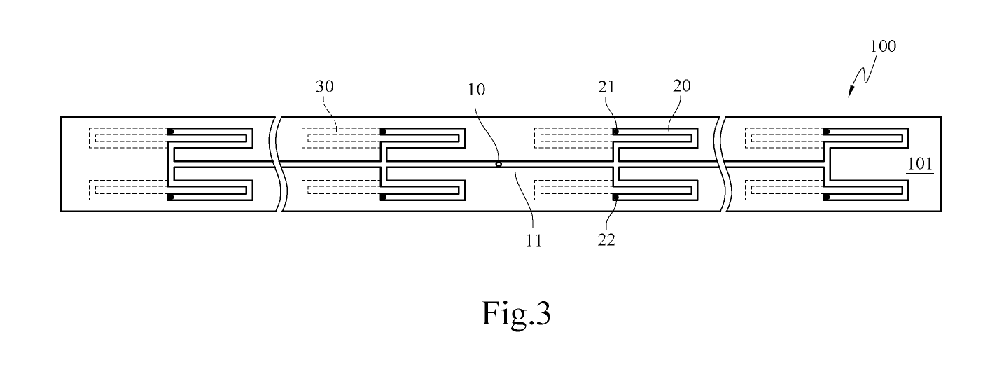

Referring to FIG. 3, a schematic front view of a first surface according to a second embodiment of the present invention is shown. As shown in FIG. 3, the difference between the second embodiment and the first embodiment of the present invention is described as follows. The second embodiment has a plurality of first radiating units 20 and a plurality of second radiating units 30, which are connected in series to form a first antenna array and a second antenna array, and a signal feed-in portion 10 located in the middle of the antenna arrays. The rest structures are identical to those in the first embodiment, so the details will not be described herein again. The number of the first radiating units 20 and the second radiating units 30 connected in series may be increased to enhance the signal intensity of the omni-directional antenna.

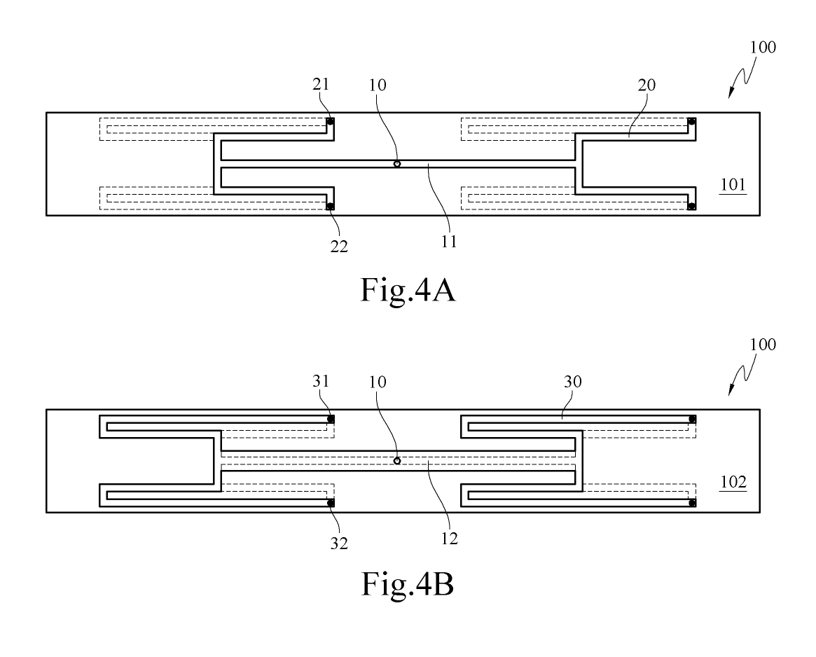

FIG. 4A is a schematic view of a first surface 101 according to a third embodiment of the present invention, and FIG. 4B is a schematic view of a second surface 102 according to a third embodiment of the present invention. The difference between the third embodiment and the first embodiment of the present invention is described as follows. The antenna graphics of the first radiating unit 20 and the second radiating unit 30 are not required to be symmetrical, and may also be different geometrical graphics. The rest structures are identical to those in the first embodiment, so the details will not be described herein again. The main purpose is to make the first radiating unit 20 and the second radiating unit 30 connected to form a circular closed loop.

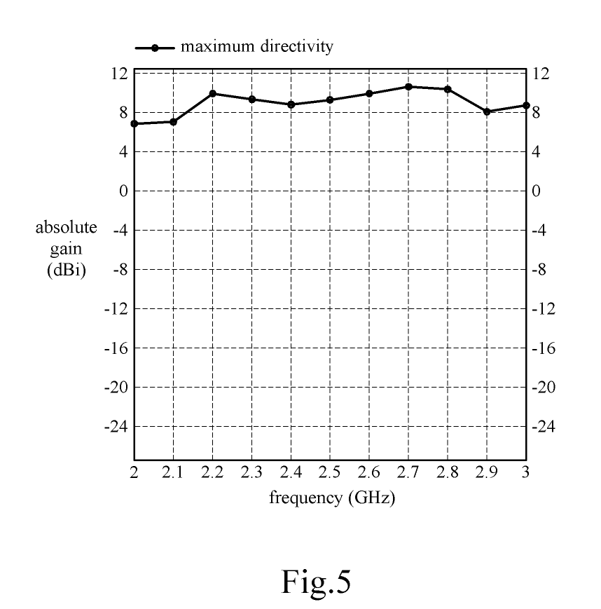

Referring to FIG. 5, a relation of directivity to frequency of a field according to the second embodiment of the present invention is shown. As shown in the figure, during the frequency 2.2 GHz to 2.8 GHz, the maximum directivity of a signal remains above the absolute gain 8 dBi.

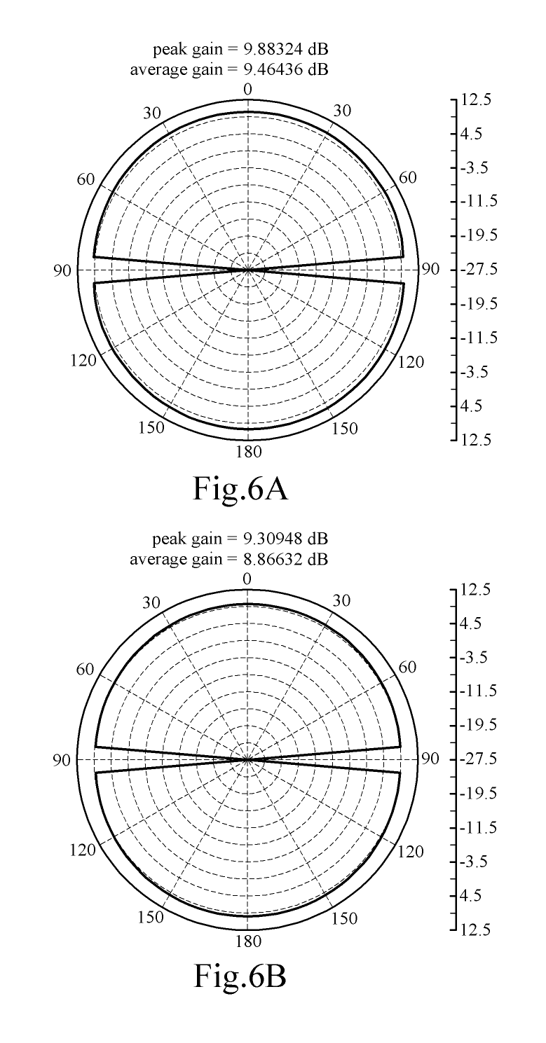

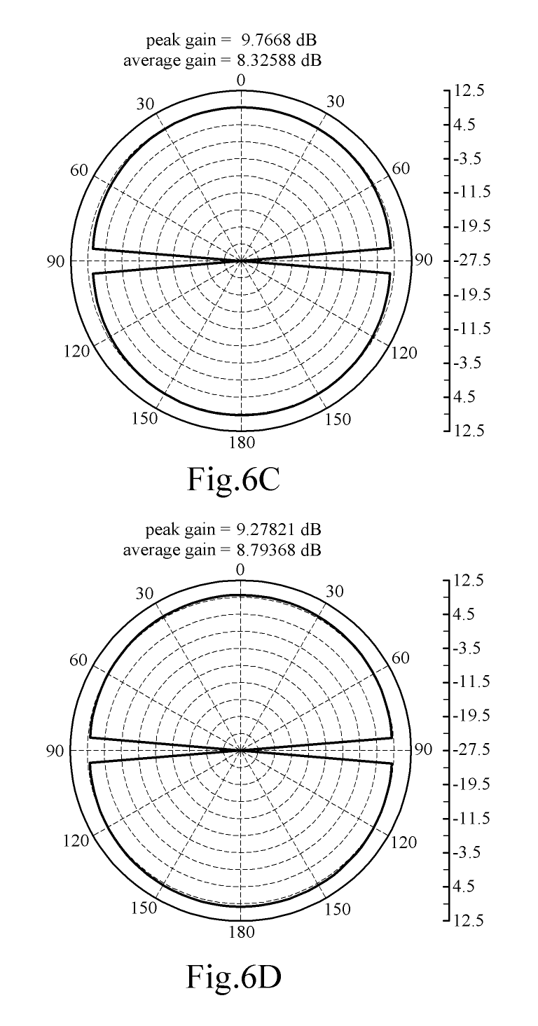

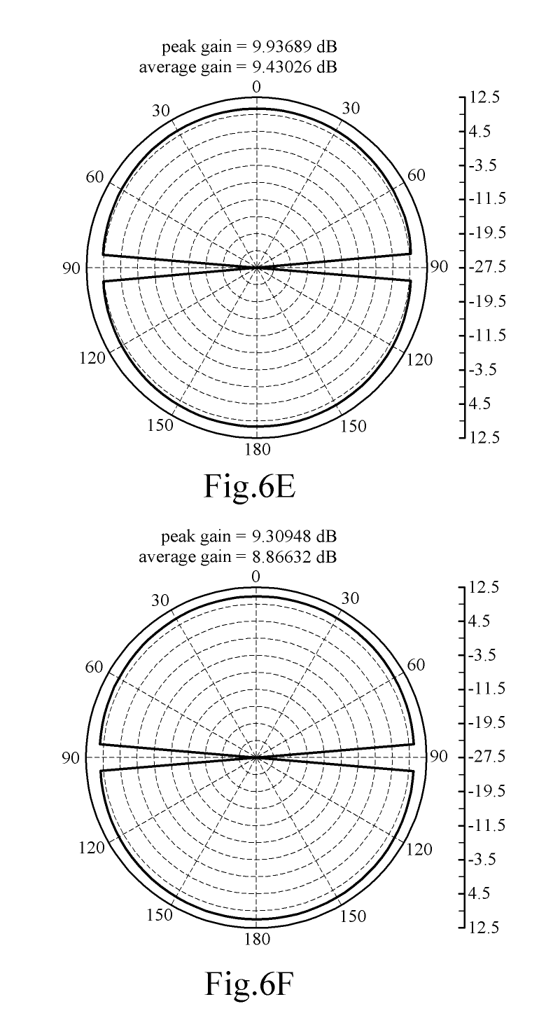

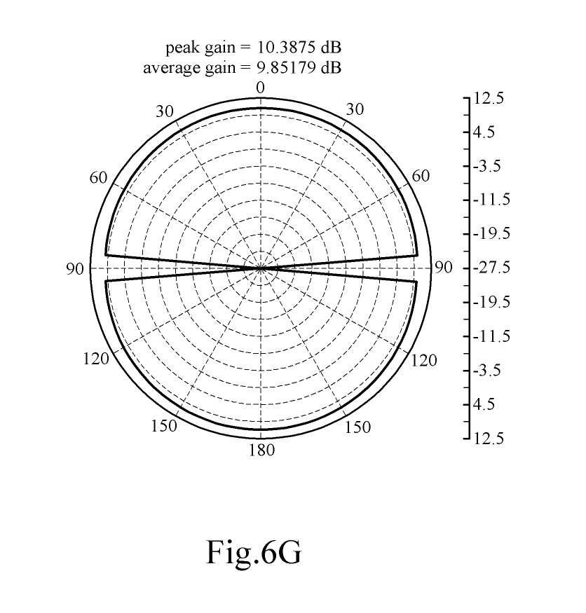

Referring to FIGS. 6A, 6B, 6C, 6D, 6E, 6F, and 6Q simulated two-dimensional radiation field patterns on a horizontal plane of the second embodiment of the present invention are shown, in which frequencies of 2.2 GHz, 2.3 GHz, 2.4 GHz, 2.5 GHz, 2.6 GHz, 2.7 GHz, and 2.8 GHz are taken for different tests. Indicated by the two-dimensional radiation field patterns, except two sides of the PCB, the signal intensities from other angles remain above 8 dB, such that the present invention provides a high gain omni-directional antenna.

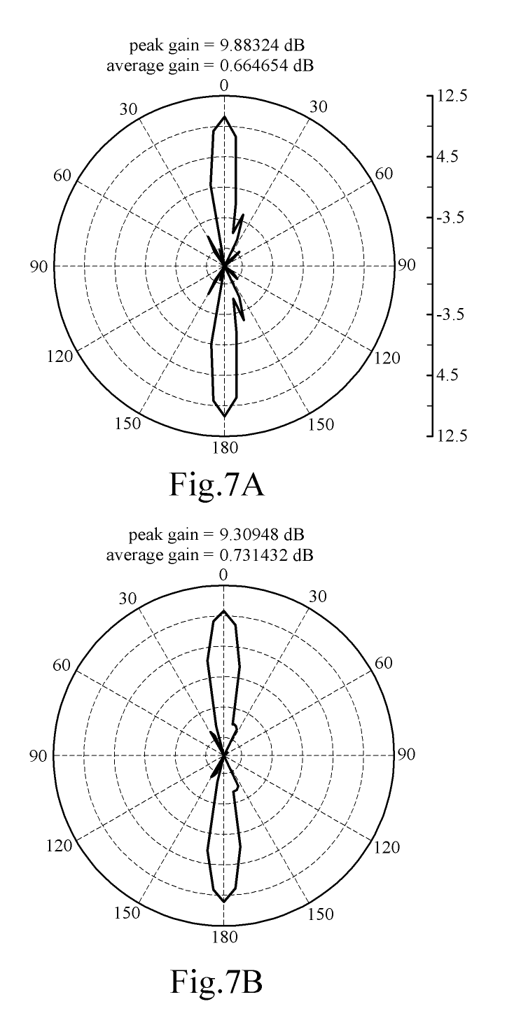

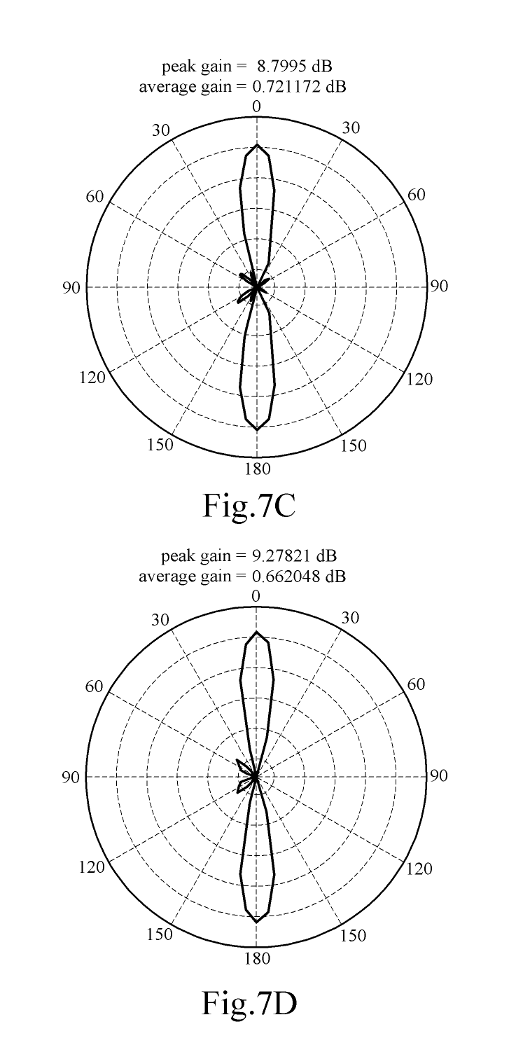

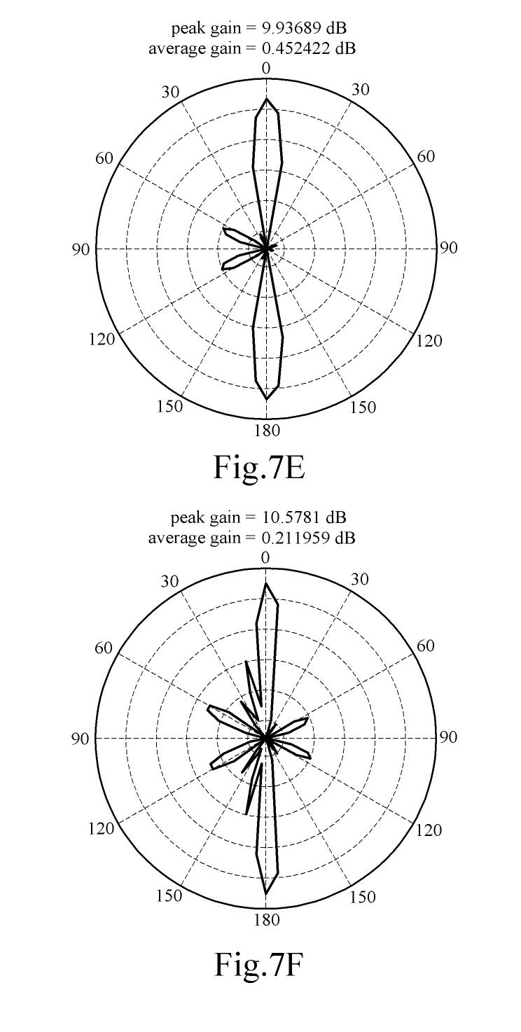

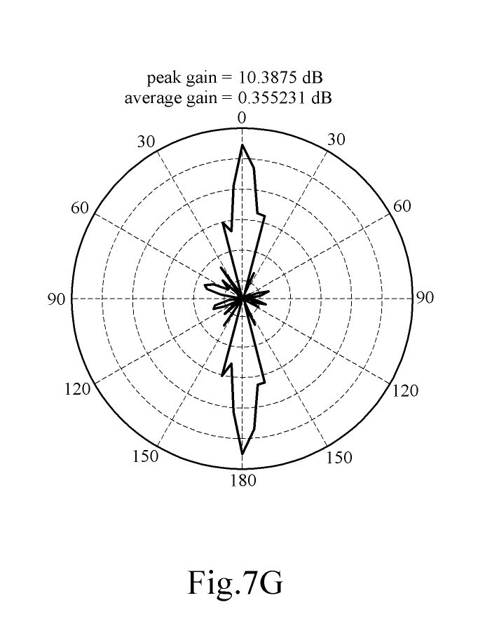

Referring to FIGS. 7A, 7B, 7C, 7D, 7E, 7F, and 7Q two-dimensional radiation field patterns of the second embodiment on a vertical plane of the present invention are shown, in which frequencies of 2.2 GHz, 2.3 GHz, 2.4 GHz, 2.5 GHz, 2.6 GHz, 2.7 GHz, and 2.8 GHz are taken for different tests. Indicated by the two-dimensional radiation field patterns, except two ends of the PCB, the signal intensity concentrates on the signal feed-in portion, and descends along with the angle toward the two ends of the PCB.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A high gain omni-directional antenna, comprising:
a substrate, having a first surface and a second surface opposite to the first surface, wherein a first metal circuit and a second metal circuit are respectively formed on the first surface and the second surface;
a signal feed-in portion, located on the first metal circuit and the second metal circuit, for receiving a feed-in signal;
a first radiating unit, formed on the first surface of the substrate, and connected to the first metal circuit, for radiating the feed-in signal received by the signal feed-in portion;
a second radiating unit, formed on the second surface of the substrate, and connected to the second metal circuit, for radiating the feed-in signal received by the signal feed-in portion;
a first radiation contact, located on the first radiating unit; and
a second radiation contact, located on the second radiating unit, and being connected to the first radiation contact so as to form a closed loop.

2. The high gain omni-directional antenna as claimed in claim 1, wherein the first radiating unit and the second radiating unit are of a same shape and are symmetrical in position.

3. The high gain omni-directional antenna as claimed in claim 1, wherein the first radiating unit and the second radiating unit are bar or finger shaped.

4. The high gain omni-directional antenna as claimed in claim 1, wherein the first radiating unit and the second radiating unit are of asymmetrical geometrical graphics of different shapes.

5. The high gain omni-directional antenna as claimed in claim 1, wherein the first radiation contact comprises a first sub-contact and a second sub-contact.

6. The high gain omni-directional antenna as claimed in claim 5, wherein the second radiation contact comprises a third sub-contact and a fourth sub-contact.

7. The high gain omni-directional antenna as claimed in claim 1, wherein the first radiation contact and the second radiation contact are connected by welding via holes penetrating the substrate.

8. The high gain omni-directional antenna as claimed in claim 1, wherein the first radiation contact and the second radiation contact are connected by wiring in the substrate.

9. A high gain omni-directional antenna, comprising:
a substrate, having a first surface and a second surface opposite to the first surface, wherein a first metal circuit and a second metal circuit are respectively formed on the first surface and the second surface;
a signal feed-in portion, located on the first metal circuit and the second metal circuit, for receiving a feed-in signal;
a plurality of first radiating units, formed on the first surface of the substrate, and connected to the first metal circuit, for radiating the feed-in signal received by the signal feed-in portion;
a plurality of second radiating units, formed on the second surface of the substrate, and connected to the second metal circuit, for radiating the feed-in signal received by the signal feed-in portion;
a plurality of first radiation contacts, located on the first radiating unit; and
a plurality of second radiation contacts, located on the second radiating unit, and being connected to the first radiation contacts so as to form a closed loop.

10. The high gain omni-directional antenna as claimed in claim 9, wherein the first radiating units and the second radiating units are of a same shape and are symmetrical in position.

11. The high gain omni-directional antenna as claimed in claim 9, wherein the first radiating units and the second radiating units are bar or finger shaped.

12. The high gain omni-directional antenna as claimed in claim 9, wherein the first radiating units and the second radiating units are of asymmetrical geometrical graphics of different shapes.

13. The high gain omni-directional antenna as claimed in claim 9, wherein the plurality of first radiation contacts comprises a plurality of first sub-contacts and a plurality of second sub-contacts.

14. The high gain omni-directional antenna as claimed in claim 13, wherein the plurality of second radiation contacts comprises a plurality of third sub-contacts and a plurality of fourth sub-contacts.

15. The high gain omni-directional antenna as claimed in claim 9, wherein the first radiation contacts and the second radiation contacts are connected by welding via holes penetrating the substrate.

16. The high gain omni-directional antenna as claimed in claim 9, wherein the first radiation contacts and the second radiation contacts are connected by wiring in the substrate.
